(19) United States
(12) Patent Application Publication
(10) Pub. No.: US 2021/0039025 A1
(43) Pub. Date: Feb. 11, 2021

(54) TRACKING WATER FILTER LIFESPAN

(71) Applicant: RACHIO, INC., Denver, CO (US)

(72) Inventors: Christopher M. Klein, Denver, CO (US); Timothy Myers, Denver, CO (US)

(21) Appl. No.: 16/944,337

(22) Filed: Jul. 31, 2020

Related U.S. Application Data
(60) Provisional application No. 62/881,223, filed on Jul. 31, 2019.

(51) Int. Cl. B01D 35/143

(52) U.S. Cl. CPC B01D 35/1435; B01D 2201/52; B01D 2201/56; B01D 2201/54

(57) ABSTRACT

Tracking a filter lifespan in a fluid supply system includes determining specifications of a filter. A flow detection device determines fluid characteristics of fluid flowing through the filter, where the fluid characteristics comprise fluid flow data. The fluid flow data is analyzed to determine fluid flow through the filter. A lifespan stage of the filter is determined based on the fluid flow through the filter.

### CROSS-REFERENCE TO RELATED APPLICATIONS

This application claims priority to U.S. Provisional Application No. 62/881,223, entitled “Tracking Water Filter Lifespan,” filed on Jul. 31, 2019, which is hereby incorporated by reference in its entirety.

This application relates to U.S. application Ser. No. 15/153,115, filed on May 12, 2016 and entitled “Flow characteristic detection and automatic flow shutoff,” now U.S. Pat. No. 9,928,724, which is hereby incorporated by reference in its entirety for all purposes.

### TECHNICAL FIELD

The technology described herein relates generally to systems including water filters.

### BACKGROUND

Filters and filtration systems remove impurities, such as toxins and debris, from water and other fluids providing clean water flow and/or purer tasting water. It is important for businesses and households to have access to clean water for drinking, bathing, cleaning, cooking, etc. Therefore, many establishments have filters installed at various locations. Filters may be installed in or around various water devices, such as, for example, refrigerators, faucets, showerheads, washing machines, dishwashers, hoses, and the like.

Physical, chemical, or biological filters typically have a finite lifespan and need to occasionally be replaced. When a filter reaches its functional capacity, its filtering performance is degraded and it may no longer properly remove impurities, resulting in unclean water. It may be important to replace the filter before it reaches its functional capacity to ensure that the filter is operating properly and dispensing clean water. Conventional techniques for tracking filter lifespan are typically centered around length of time, e.g., replace filter in 6 months. These types of tracking are not accurate and result in filters that are replaced too early and too late. Further, in some geographic areas, increased contaminates may require more frequent replacement of filters than would be otherwise recommended to provide a safe water supply.

The information included in this Background section of the specification, including any references cited herein and any description or discussion thereof, is included for technical reference purposes only and is not to be regarded subject matter by which the scope of the invention as defined in the claims is to be bound.

### SUMMARY

An exemplary method of tracking a filter lifespan in a fluid supply system determines specifications of a filter. A flow detection device determines fluid characteristics of fluid flowing through the filter, where the fluid characteristics comprise fluid flow data. The fluid flow data is analyzed to determine fluid flow through the filter. A lifespan stage of the filter is determined based on the fluid flow through the filter.

An example filter monitoring system includes a first flow path and at least one fluid device fluidly coupled to the first flow path. A filter is fluidly coupled to the first flow path distal to the at least one fluid device. A downstream flow sensor fluidly connected to the first flow path between the at least one fluid device and the filter is configured to detect a downstream flow rate of fluid exiting at least the filter through the first flow path. A processing element in communication with the downstream flow sensor and a user device determines a life cycle stage of the filter based on at least the downstream flow rate detected by the downstream flow sensor.

An exemplary method of tacking compliance to one or more water requirements by a water utility is presented. One or more processing elements in communication with a plurality of flow sensors each fluidly connected to one of a plurality of filters at each unit of a plurality of units in a predetermined geographic area determine a flow rate through the filter at each unit of the plurality of units. For each unit of the plurality of units, the one or more processing elements determine if the flow rate through the filter at the unit is below a predetermined threshold. The one or more processing units transmit an alert to the water utility if the flow rate through the filter at a predetermined percentage of units of the plurality of units in the predetermined geographic area is below the predetermined threshold.

Additional embodiments and features are set forth in part in the description that follows, and will become apparent to those skilled in the art upon examination of the specification and may be learned by the practice of the disclosed subject matter. A further understanding of the nature and advantages of the present disclosure may be realized by reference to the remaining portions of the specification and drawings, which form a part of this disclosure. One of skill in the art will understand that each of the various aspects and features of the disclosure may advantageously be used separately in some instances, or in combination with other aspects and features of the disclosure in other instances.

### BRIEF DESCRIPTION OF THE DRAWINGS

FIG. 1 is a block diagram of a filter monitoring system for a fluid flow system including a flow detection device.

FIG. 2 is a schematic diagram of a select portion of the fluid flow system.

FIG. 3 is a flow chart illustrating a method to track filter life cycle.

FIG. 4 is a flow chart illustrating a method to predict remaining filter life using flow volume data.

FIG. 5A is a first example of a filter status display for a user device.

FIG. 5B is a second example of a filter status display for a user device.

FIG. 5C is a third example of a filter status display for a user device.

FIG. 5D is a fourth example of an interactive filter status display for a user device.

FIG. 6 is a block diagram of a system architecture that may be used with the filtration system of FIG. 2.

FIG. 7 is a schematic diagram of an exemplary computer system for detecting filter status as described herein.

FIG. 8 is a simplified block diagram of a system for using flow rate through a filter to determine filter effectiveness.

FIG. 9 is a screen shot of an illustrative graphical user interface for displaying filter effectiveness for the system of FIG. 8.

FIG. 10 is a flow chart illustrating a method for determining filtering effectiveness for a set of water zones.

### DETAILED DESCRIPTION

In some embodiments herein, a filter monitoring system is disclosed. The monitoring system uses filter characteristic data and fluid flow data to determine a current state or status of the filter and analyze the lifespan of the filter to provide alerts regarding filter replacement.

The current filter state may correspond to a lifespan or life cycle stage of the filter. A filter may have a particular lifespan, reaching its maximum functional capacity at the end of its lifespan. For example, a physical filter may be made of material that wears down after it has filtered 10,000 gallons of water, such that at the maximum gallon capacity the filter may no longer properly remove impurities, thus reaching the end of its lifespan. As another example, with a chemical filter, the filter may include sufficient active agents to clean or treat 6,000 gallons, or the chemical concentration may be reduced significantly after 6,000 gallons has flowed through the fluid system, such that the filter's functional capacity will be reached when 6,000 gallons have flowed through the filter.

When a filter reaches a usage threshold or related stage, it may be desirable to replace the filter since its effectiveness will likely drop due to degradation or depletion of the filtering material. In several embodiments, the filter monitoring system may determine the lifespan stage of the filter using data on detected fluid characteristics of fluid flowing through the filter. Based on the current stage in comparison to the overall lifespan of the filter, along with predicted future use, the monitoring system may determine the remaining life of the filter. Depending on the remaining life the monitoring system may determine that the filter may need replacement and can provide an alert, directly order a filter replacement, or the like.

The current system can track exact fluid flow through a particular filter, allowing an accurate determination of the remaining life of the filter. Conventional detection methods did not detect exact flow through a filter, but rather used rough estimates based on conventional home usage through a particular water consumption device, e.g., a typical person uses X gallons through the kitchen faucet in a 6 month period. As such, these systems resulted in early or late filter replacement notifications and either wasted filters thrown out before the end of their useful life or unclean water. The method of the present disclosure tracks flow through various fluid consumption devices such that the life of the filter can be accurately detected and a filter is replaced exactly at its replacement time, reducing waste and the risk of unclean water being delivered to a user.

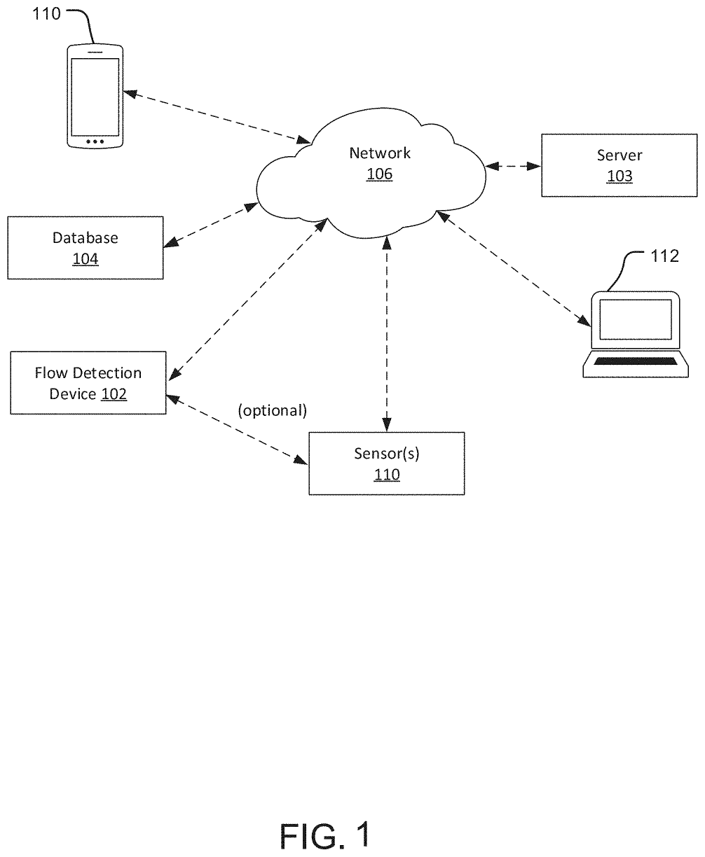

Turning now to the figures, the filter monitoring system will now be discussed in more detail. FIG. 1 is a block diagram of a filter monitoring or lifespan tracking system 100. The filter monitoring system 100 may include a flow detection device 102, one or more servers 103 or other computing devices, one or more databases 104 (which may be connected to or integrated with the server 103), one or more user devices 112, 114, and optionally one or more peripheral sensors 110, each of which may be in communication with one another directly or indirectly via a network 106.

The flow detection device 102 detects flow characteristics of fluid flow through a fluid system (e.g., water pipes within a house, condo, etc.) as well as flow data from one or more fluid consuming sources (e.g. faucet, showerhead, washing machine, dishwasher, hose, etc.). The flow detection device 102 may be the same or similar to the flow detection hub described in U.S. Pat. No. 9,928,724, incorporated herein by reference, or it may be any device that detects fluid characteristics within a water flow system, such as an ultrasonic flow sensor, a water level sensor, conductivity probes, rotameter, velocity flowmeter, turbine flowmeter, electromagnetic flowmeter, and the like. In some embodiments, the flow detection device 102 may be a utility water meter that may be positioned outside of the fluid system and used for purposes, such as billing, by a third party.

The flow detection device 102 may be any smart fluid detection device configured to monitor fluid flow, collect data on various fluid characteristics, and analyze the data to associate the data with specific water or fluid devices and/or filters in the fluid flow system. In some implementations, the flow detection device 102 may be implemented by, or use data from, utility meters in use in a fluid system. The flow detection device 102 may gather such data as fluid flow data (e.g. flow rate, fluid pressure, pressure changes, frequency, total amount of flow, viscosity, etc.), fluid quality and composition information (e.g. pH, salinity, electric conductivity, dissolved oxygen, chemicals and/or nutrients, etc.), fluid temperature, or the like. The flow detection device 102 may use data from the sensors 110 to determine the flow rate, flow pressure, and other fluid characteristics, as well as system data (e.g., number of fluid consumption devices connected to the main distribution source, elevation changes in the system, etc.). It is also contemplated that the flow detection device 102 may be a network of smart sensors detecting various fluid characteristics and transmitting the detected fluid data to the system 100. The flow detection device 102 is in communication with one or more servers 103 through the network 106. The flow detection device 102 may be configured to store the collected and analyzed data and to transmit the data to the one or more servers 103.

The peripheral sensors 110 may be substantially any type of sensors for detecting fluid flow into and/or out of a device. For example, the sensors 110 may detect vibrations in a fluid supply pipe into a device and/or filter to detect flow into the device and/or filter, such as by connecting around or to a pipe. As another example, the sensors 110 may be conductivity sensors to detect standing water, temperature sensors, pressure sensors, pH sensors, or the like. In other examples, the sensors 100 may be implemented within a utility meter or other fluid flow meter in a fluid system. The sensors 110 can be used to supplement data detected by the flow detection device 102 and/or replace certain data detected by the flow detection device 102.

The sensors 110 are typically positioned at various locations in the fluid system. For example, the sensors 110 may be positioned near individual water fixtures, such as a kitchen sink, toilet, showerhead, or the like. The peripheral sensing functionality provided by the sensors 110 allows the filter monitoring system 100 to more accurately detect flow within the system; identify leak locations, devices, and filters quickly; and provide more accurate monitoring of water usage in the system. The sensors 110 may communicate directly with the flow detection device 102 or may communicate via the network 106 with the flow detection device 102.

In some embodiments, the sensors 110 may be omitted and the flow detection device 102 may detect all the desired fluid characteristics in the main system, such as, for example, by detecting changes in fluid flow characteristics though the main flow pathway 152, discussed in more detail below.

The network 106 may be substantially any type of data communication pathway or series of pathways. For example, the network 106 may be WiFi, Bluetooth, or other radio wave based system, and one or more user devices 112, 114. It should be noted that the connection between the network 106 and the various devices may be direct (e.g., the device is WiFi enabled and directly communicates data across the WiFi network) or indirect (e.g., a sensor is directly wired to another device and the secondary device communicates via the WiFi network).

The user devices 112, 114 may be substantially any type of computing device, such as, but not limited to, a computer, a laptop, a tablet, a smart phone, a wearable device, or the like. The user devices 112, 114 may also be one or more smart home accessories, such as, cameras (e.g., live or still image cameras), smart thermostats, alarm systems, locking devices, or the like.

Additionally, although two user devices 112, 114 are illustrated, the system 100 may include fewer or more user devices 112, 114. Similarly, the user devices 112, 114 may be configured to receive different data from one another. For example, one user device 112 may be tied to a homeowner account and a second user device 114 may be tied to a service account to allow professionals (e.g., a filtration company, water utility, or the like) to view and access data regarding the user account. The type of data visible to each of the user devices 112, 114 may be varied, such that a homeowner account may have more access than a service account.

The server 103 may be one or more computing devices in communication with one another that are capable of storing data on one or more memory components and transmitting data between the various devices in the system 100. The server 103 may also be used to execute a number of algorithms and operations to generate water usage patterns, typical fluid flow rates, leak detection, and the like. This allows the flow detection device 102 to be simplified in terms of processing power and the like. The server 103 may be a centralized computing resource or decentralized across multiple computing resources (e.g., cloud based computing). The type and structure of the server 103 may vary depending on the application.

The database 104 may provide additional storage space on one or more memory components. The database 104 may be accessible to one or more users, one or more service providers, or both. In some embodiments, the database 104 stores data corresponding to filter characteristics (e.g., filter material, strength, flow life, and the like), as well as fluid characteristic data. There may be separate databases for each type of data, e.g., a database for filter information and a database for flow data. The database 104 may include or otherwise be linked to a manufacturer database for a filter or range of filters (or other data store) to retrieve or access certain data corresponding to the filter that is used to assess the filter lifespan.

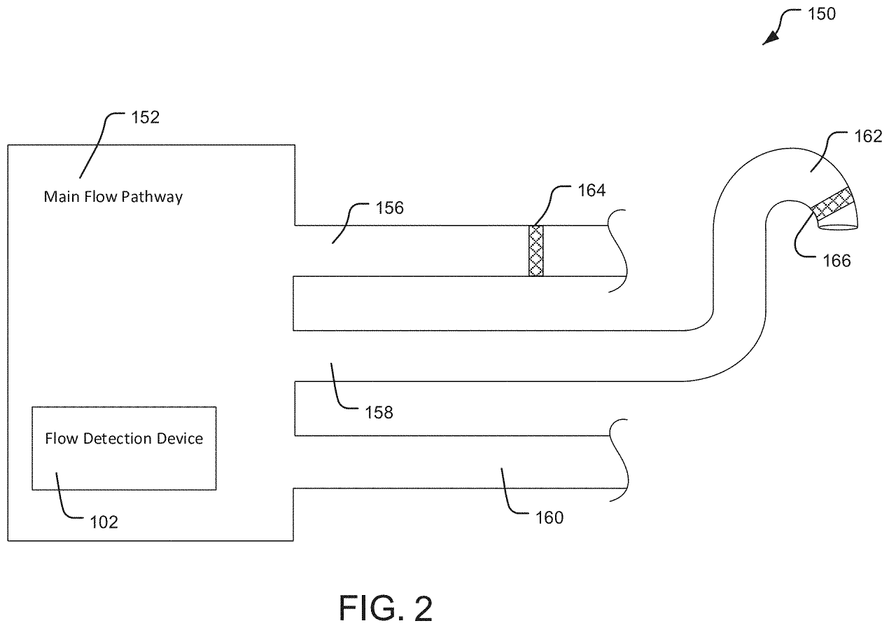

The filter and fluid systems will now be discussed in more detail. FIG. 2 is a schematic diagram of a filtration system within a fluid flow system 150. As shown in FIG. 2, the fluid flow system 150 may include a main flow pathway 152 including several different flow paths 156, 158, 160. In the example shown, there are three flow paths including a first flow path 156, a second flow path 158, and a third flow path 160; however, the number of flow paths depicted is only exemplary and many flow paths are contemplated depending on the number of water-consuming devices in the building or household. Each flow path may fluidly couple the main flow pathway 152 to one or more water consumption or utilization devices 162, such as, for example, a faucet, a showerhead, a dishwasher, etc. For example, each flow pathway may be a pipe branching off from the main water pipe in a house, either directly or indirectly, to deliver fluid to different locations within the house.

The fluid flow system 150 may also include a filtration system, which includes one or more filters positioned between the water inlet into the flow system and a water outlet. The filters may be positioned at various locations within the fluid system and may vary as desired, e.g., some locations may include a filter at each outlet, whereas others may include a whole house type of filter that seats within the main flow passage. In the example shown in FIG. 2, the first flow path 156 includes a path filter 164, which seats inside the flow path 156, remote from the one or more fluid or water devices 162 fluidly connected to the main flow pathway 152, but still positioned between the inlet of the house and the delivery outlet(s) of the various devices. The second flow path 158 is fluidly connected to one or more water devices 162, which include a device filter 166. The device filter 166 may seat inside or adjacent to the water device 162. In most embodiments, the filters are positioned so that water flows through them before being delivered to the fluid consumption device so as to remove impurities before delivery.

The filters 164, 166 may be any type of filter, such as, for example, a mechanical, chemical, or biological filter. A mechanical filter may be any filter that uses a material or other mechanical means to catch particulate matter. A chemical filter may be any filter that uses a chemical media or resin to attract and hold other chemicals in the fluid stream. A biological filter may be any filter that uses bacteria to convert impurities in the fluid into less toxic substances or nutrients. Examples of potential filters that may be used in the fluid flow system 150 include activated carbon or resins, reverse osmosis filters, nylon filters, micropore filters, alkaline/water ionizers, UV filters, infrared filters, or the like. Each filter may have a predetermined size, manufacturer, type of material, and estimated flow capacity that corresponds to the number of gallons that can reliably be filtered by the filter.

The fluid flow system 150 may also include a flow detection device 102, as discussed in more detail above. The flow detection device 102 may couple to the main flow pathway 152 and/or to one or more flow paths 156, 158, 160 within the fluid flow system 150 so as to be able to track the fluid characteristics of flow through each of the pathways and/or through each of the fluid consuming devices. In this manner, with knowledge of the filter location, the flow detection device can determine the fluid characteristics of fluid that flows through each of the filters.

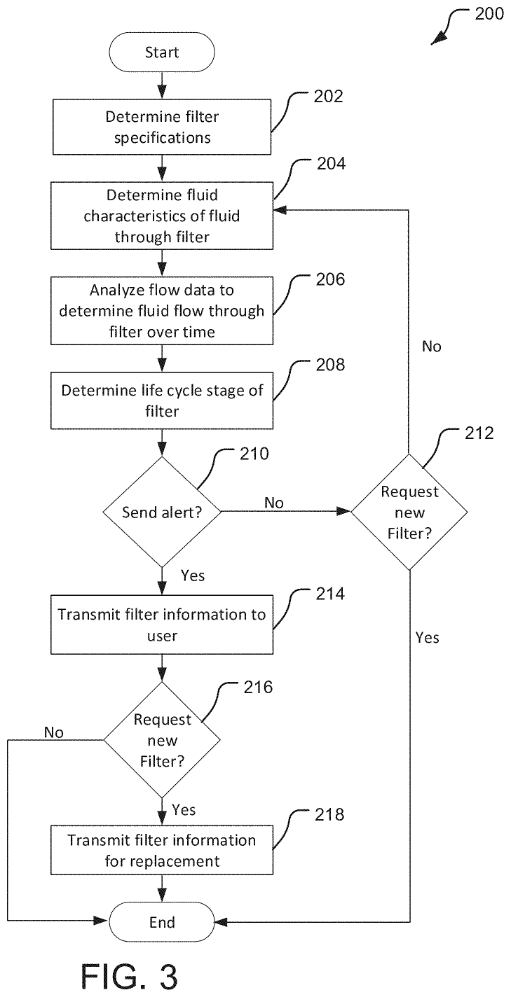

FIG. 3 is a flow chart illustrating a method 200 of tracking a life cycle of a filter using the system of FIG. 1. The method 200 may begin with operation 202 and the filter specifications for each of the filters 164, 166 are determined. Filter specifications may include the type, make, size, model, brand, material, installation date, number of filters (e.g. if more than one filter is used in the fluid system or for a single fluid device), number of devices fluidly coupled to the filter, or the like. The filter specifications may be determined in various ways, such as, for example, by user input into a user device and/or into the flow detector 102, input from a database 104, or a combination of both.

In one example, a user may input information about a specific filter into the filter life cycle tracking system 100 through a user device 112, 114. For example, a user may input the date of installation, the material and size of the filter, the flow rate life of the filter, the location of the filter in the fluid system (e.g. whether the filter is a path filter 164 or a device filter 166 and which devices feed through the filter), and the one or more devices fluidly coupled to the filter. As another example, the system 100 may receive filter information from a database 104 in communication with the system 100. For example, the database 104 may have stored information on the specifications for each specific filter or the database 104 may store filter specifications based on the brand of filter. As yet another example, a user may provide a picture or a bar code scan of the filter to the system 100, and the system 100 may then acquire information on the filter from a database 104, such as, for example, the filter manufacturer's database storing product information. In another example, a user may input the brand of the filter, and the system 100 may receive additional information on the filter from the database 104 based on the brand of the filter.

After operation 202, the method 200 may proceed to operation 204 and fluid characteristics of fluid flowing through the filter are determined. Fluid characteristics may include fluid flow data (e.g. flow rate, water pressure, pressure changes, frequency, total amount of flow, viscosity, etc.), fluid quality and composition information (e.g. pH, salinity, electric conductivity, dissolved oxygen, chemicals and/or nutrients, etc.), fluid temperature, or the like. The flow data may also include information on flow events, such as, for example, whether a flow event is normal or abnormal, such as a leak or break, average or estimated flow rates for different flow events, and/or the frequency and/or timing of flow events; typical usage patterns and any deviations from those patterns; deltas to flow patterns; and the like. The fluid characteristics may be determined in various ways, such as, for example, by input from at least one of the flow detection device 102 and the sensors 110.

In one embodiment, the flow detection device 102 may be used to detect flow characteristics in the fluid flow system 150. As mentioned, the flow detection device 102 may be used with the sensors 110 or it may be used alone to detect flow characteristics. In the embodiment with sensors 110, the sensors 110 may be one or more peripheral or fluid source sensors. The positioning of the sensors 110 throughout the fluid flow system 150 may provide more accurate monitoring of water usage in the system. The sensors 110 may include one or more flow sensors that detect a flow rate of fluid flowing through the fluid supply pipe. The flow sensor 102 may be substantially any type of flow detection sensor, but in many embodiments, it may be an ultrasonic sensor that uses ultrasonic waves to detect the fluid characteristics. The flow sensor 102 may be used to determine the viscosity of the fluid, as well as other flow characteristics. In an alternate embodiment, one or more flow sensors may be integrated into the flow detection device 102.

In embodiments that omit the sensors 110, the flow detection device 102 may detect deltas to the flow pattern and correspond deltas to flow events, which may then be tied to certain devices, leaks, abnormal use or the like. In several embodiments, the flow detection device 102 may be a low-flow detection device, capable of more accurately detecting small fluid flows, such as, for example, a running toilet, small leak, or the like. The flow detection device 102 may be calibrated to determine flow signatures for various devices and associated filters connected to the fluid flow system 150. For example, the flow detection device 102 can be configured to detect the flow signature for a dishwasher, showerhead, master bathroom toilet, guest toilet, kitchen sink, etc. By assigning flow signatures to each of the devices, the flow detection device 102 can determine when a particular device is being used. Because each device may be associated with one or more filters, the flow detection device 102 may also be able to determine when particular filters are being used. In an alternate embodiment that includes sensors 110, the flow detection device 102 may be able to use the sensors 110 to determine when a particular device, and subsequently a particular filter, is being used.

In several embodiments, the sensors 110 may include a fluid quality sensor, a pressure sensor, a temperature sensor, or the like. The fluid quality sensor may be substantially any type of device that can detect composition characteristics of fluids within the fluid flow system 150, e.g., pH, salinity, electric conductivity, dissolved oxygen, chemicals and/or nutrients (ammonia, nitrate, phosphate), or the like. For example, the water quality sensor may be a total dissolved solids (TDS) sensor that uses electrical conductivity in the fluid to detect the presence of certain chemicals, a spectrometer or the like. The sensors 110 may transmit the detected fluid characteristics to the one or more servers 103.

After the fluid characteristics are determined at operation 204, the method 200 may proceed to operation 206 and the flow data from the flow detection device 102 and/or sensors 110 is analyzed to determine the fluid flow through each filter over time. As mentioned, fluid flow to specific devices may be tracked in various ways, such as for example, by identifying delta patterns or flow signatures that are associated with a specific device or by fluid source filters (e.g. device filter 166) that monitor fluid flow at the device and tracking the flow signatures or local flow use over time. With the filter specifications provided at operation 202, the system 100 can determine the flow through each filter or filters associated with each device. For example, with reference to FIG. 2, the locations of the filters 164, 166 throughout the fluid flow system 150 may be known, as well as the devices 162 associated with each flow pathway 156, 158, 160. In this manner, the detected flow to a specific device 162 may correlate to flow through a filter 166, e.g., assume that all the flow output by the device 162 is flow that is flowing through the filter. Using the current flow data and any existing historical flow data (e.g., prior flow through the device), the flow to each filter over time may be determined. Historical flow data may be determined from typical usage patterns received from the flow detection device 102 or it may be actual flow data collected and stored over time by the system 100. For example, typical usage patterns may be used to predict flow to a particular device, and any associated filter, over time.

After operation 206, the method 200 may proceed to operation 208 and the life stage of the filter may be determined. Each filter may have a different lifespan based on its specific specifications and the fluid characteristics of fluid flowing through the filter. For example, some filters may be more durable depending upon the type of filter, the material used, the thickness of the filter, and the like. More durable filters may have a longer lifespan than weaker filters.

Fluid characteristics of fluid flowing through the filter may also be important factors in determining the lifespan of the filter. For example, the more fluid that flows through the filter over time, the more the filter may degrade over time. Other fluid characteristics may also play a role in the filter's degradation over time, such as, for example, the water's pH level, pressure, temperature, chemical or mineral composition, or the like., e.g., hard water with heavy minerals may cause build up on the filter, and, depending upon the type of filter, may reduce the lifespan of the filter, whereas a filter in a non-hard water system with a similar flow therethrough may have a longer life.

Using the collected data on filter specifications and fluid characteristics, the system 100 determines the overall lifespan of the filter. As one example, the filter's lifespan may be solely determined based on the fluid flow through the filter. For example, the filter may have a maximum fluid volume capacity, such that the filter is only capable of filtering a particular volume of fluid over its lifetime. The filter specifications may provide such information on a maximum fluid volume capacity to the system 100. For example, the filter's maximum fluid volume capacity may be determined from a user manual, retrieved from the manufacturer, determined by analyzing filter characteristics, or the like. As one example, based on the filter specifications determined at operation 202, it may be determined that the filter is capable of filtering 40,000 gallons of water over its lifetime. Once the filter has filtered 40,000 gallons of water, the filter may reach the end of its lifespan, or its functional capacity, and need replacement.

Based on the overall lifespan of the filter and the filter and fluid information, the current stage of the filter may be determined. For example, based on the installation date of the filter, which may be entered by the user at the time of install, and then using the fluid flow through the filter over time, as determined at operation 206, the total amount of water that has flowed through the filter may be determined. Based on the determined fluid volume through the filter and the maximum fluid volume capacity, the life cycle stage of the filter may be determined. In the above example, it may be determined that the filter has filtered 20,000 gallons of water and is therefore at 50% of its maximum fluid volume capacity of 40,000 gallons, or at the half-way stage in its life cycle. As another example, it may be determined that the filter has filtered 36,000 gallons of water and is at 90% of its capacity. In this example, the life cycle stage of the filter correlates to the percent capacity of fluid flow through the filter; however, other indicators of life cycle stage are contemplated. As one example, when other fluid characteristics are taken into account, such as, for example, pH, pressure, temperature, and the like, a condition of the filter may be determined, where the condition may correlate to a percent degradation or any other amount of deviation from the original state of the filter when the filter was first installed. The condition may be further determined through a visual analysis, if, for example, the system 100 includes visual sensors (e.g. cameras) near the filters. The present condition of the filter may correlate to the life cycle stage of the filter.

After operation 208, the method 200 proceeds to operation 210 and the system 100 determines whether to send a notification or an alert to a user. In one embodiment, the system 100 may be programmed to send notifications to a user whenever fluid flows through the filter, constantly updating the user on the filter's status. In this manner, a user may be able to monitor each filter over time and observe when a filter is approaching the end of its lifespan. In this embodiment, the system 100 may also send an alert when the filter is near its end as a reminder to the user to replace the filter.

In another embodiment, the system 100 may send notifications or alerts to a user at specific life cycle stages of the filter. For example, the system 100 may store preset parameters indicating a threshold life cycle stage for each filter. The threshold life cycle stage may indicate a stage in the life cycle where it may be desirable to replace the filter. Thus, when the filter approaches the threshold life cycle stage, it may indicate that a replacement may be necessary in the near future, and when the filter surpasses the threshold life cycle stage, it may indicate that the filter may need to be replaced. As one example, the threshold life cycle stage may be anywhere from 70-100% of the filter's total capacity. As another example, the threshold life cycle stage may be 85% capacity. In this example, if the system 100 determines at operation 208 that the filter is at 70% capacity, then the system 100 may determine that the filter may need replacement in the near future and send an alert to a user to replace the filter soon; however, if the system 100 determines that the filter is at 90% capacity, exceeding the 85% capacity threshold, then the system 100 may determine that the filter needs to be replaced and send an alert to a user to replace the filter now.

The threshold stage may depend upon the filter specification determined at operation 202. For example, a more vital filter, such as, for example, a filter for a kitchen faucet for drinking water, may need to be replaced sooner and may have a lower threshold stage than a filter that is less vital to a user's health. As another example, a larger filter may have a lower threshold stage than a smaller filter, as it may have more fluid flow through in a given time and/or it may take a longer time to replace. In one embodiment, a user may set or adjust the threshold life cycle stage if a user desires to replace a filter sooner or later than the timeframe programmed in the system 100.

If the system 100 determines that no alert should be sent at operation 210, the method 200 may proceed to operation 212 and the system 100 determines whether to request a new filter. The system 100 may request a new filter based on user input and/or based on the life cycle stage of the filter. At operation 212, there may be no user input since an alert has not been sent to a user. In one embodiment, the system 100 may be programmed to automatically request a new filter without sending any alerts to a user when the filter exceeds its threshold life cycle stage. In this embodiment, when the system 100 determines that the filter exceeds its threshold life cycle stage, the system 100 may request a new filter and the method 200 ends. However, when the system 100 determines that a request for a new filter is not necessary at the present life cycle stage of the filter, then the method 200 proceeds to operation 204 and the system 100 again determines the fluid characteristics of fluid flow through the filter.

If the system 100 determines that an alert should be sent at operation 210, the method 200 may proceed to operation 214 and the filter information and/or a recommendation for a filter replacement may be transmitted to a user. The filter information may be the life cycle stage of the filter, such as, for example, the filter's percent capacity, percent degradation, or condition. The filter information may include information on the fluid characteristics of fluid passing through the filter. The recommendation for a filter replacement may be to replace the filter soon, to replace the filter in a specific timeframe, or to replace the filter now. The information transmitted may be in the form of text or visual elements indicative of filter status. The system 100 may provide the information to a user as push alerts to a user's device 112, 114. Alerts may be transmitted in a number of different manners, such as, for example, alerts in a user application, text message, emails, haptic responses (e.g., vibrations, tapping), or the like. It is contemplated that a user may vary the alert settings of the system 100 as desired. In some embodiments, the alerts may be sent in conjunction with a new filter order that may be placed automatically. For example, the alert may provide a message to the user device that a new filter has been order or will be ordered shortly and the user may have the option to cancel the order or may otherwise just be aware that the filter will be arriving and his or her location.

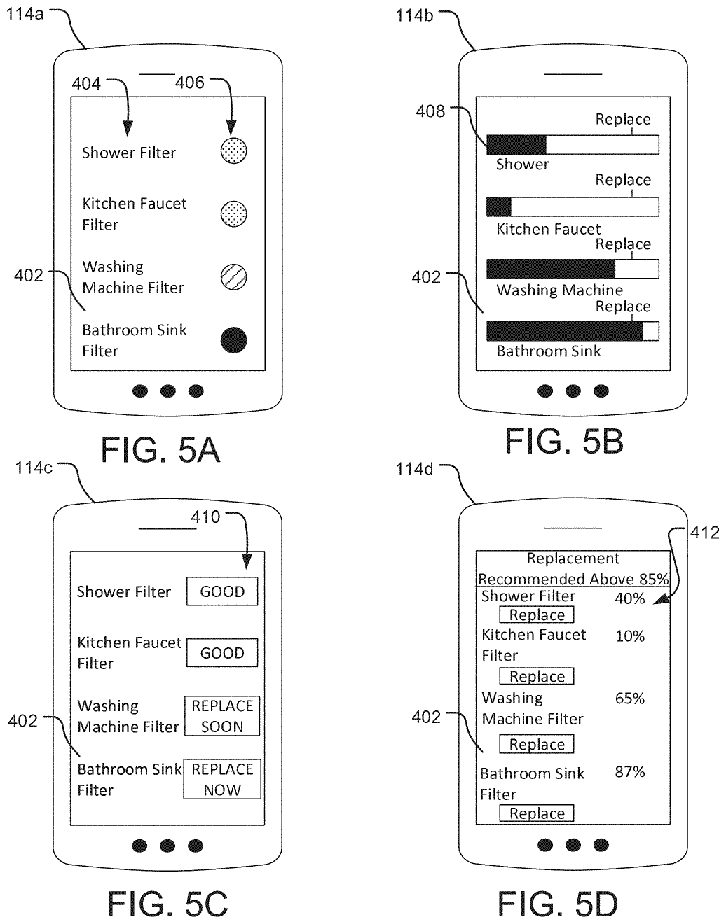

As shown in FIGS. 5A-D, the user device 114 may include a user application is viewable on a user interface or display 402 on the user device 114a-d. The user application may provide real-time information on the status of the filtration system, including the current status or state for each filter. As shown in FIG. 5A, the display 402 on the user device 114a may illustrate the specific filters 404 in the filtration system and include a status indicator 406, which may be in the form of a list or other arrangement. In the example shown in FIG. 5A, the status indicator 406 may be one or more light emitting diodes (LEDs) or other visual elements that illuminate in different colors and/or patterns to indicate a certain status. For example, there may be a green, yellow and red indicator 406, each defining a different status. For example, green may mean the filter is in good condition, yellow may mean the filter is approaching its end and serve as a warning symbol, and red may mean the filter has reached its end and needs to be replaced.

FIG. 5B depicts another example of a user interface 402 displaying filter status to a user on a user device 114b. In this example, the display 402 uses indicator bars 408 with markers to indicate filter status. In the depicted example, each indicator bar 408 represents a lifespan of a filter. Each bar 408 has a marker that indicates “Replace” towards the end (the right side) of the bar. The bars fill in a dark shade as the filter ages and approaches the end of its lifespan. The more shading in the bar indicates the filter is getting closer to the end of its lifespan. When the filter reaches and/or surpasses the “Replace” marker, it indicates to a user that the particular filter needs to be replaced. In this manner, a user may monitor each filter over time. However, it should be noted that in other embodiments, other icons and display arrangements may be used.

FIG. 5C shows yet another example of a filter status display 402 for a user device 114c using language indicators. In this example, each filter is listed, and the status for each filter is listed next to the filter. The status may be any word that is informative to a user of a status of a filter. In the example shown, the status may be “GOOD,” “REPLACE SOON,” or “REPLACE NOW.”

FIG. 5D provides an additional example of a filter status display 402 for a user device 114d using percentage indicators. In the example shown, the percent capacity 412 for each filter is indicated. For example, the percent capacity 412 for each filter depicted is 40%, 10%, 65%, 87%. As mentioned previously, the percent capacity may indicate the life cycle stage of the filter, e.g., remaining effectiveness. The display 402 may provide information on the threshold capacity, indicating to a user when to replace a filter based on the percent capacity 412. In the example shown, the display 402 indicates that the threshold capacity is at 85%, indicating to the user that the user should replace a filter when it exceeds 85% capacity. In this example, the display 402 indicates that the bathroom faucet filter, which has reached 87% capacity, should be replaced. While this example only shows a single threshold capacity for all filters, it is contemplated that the display 402 may indicate a different threshold capacity for each filter individually.

In some embodiments, the user interface 402 may also provide the user access to additional information about the filtration system and the fluid flow system 150. For example, the user application may also provide real-time information for the flow detection device 102 that indicates to the user the status of the flow throughout his or her property (e.g., house, apartment, building, or the like). Additionally, the user application may also define a communication pathway that may be used to allow the user to input commands to the filter monitoring system 100, as well as allows the filter monitoring system 100 to transmit information to the user (e.g., filter status). The user application may be set to be web-based and/or mobile (e.g., smart phone) based. Examples of additional features of the application may include, but are not limited to, user login, request new filter, open/close main water supply, water budgeting, alerts and messaging, real-time flow display, and/or water usage information (e.g., charts).

With continued reference to FIG. 3, after operation 214, the method 200 proceeds to operation 216 and the system 100 determines whether to request a new filter. As mentioned previously, the system 100 may request a new filter automatically based on the filter status or based on user input. In one embodiment, the system 100 may automatically request a new filter at operation 216 after determining that the filter is at a particular life cycle stage and alerting the user of its status. For example, the system 100 may automatically request a new filter when the filter has surpassed its threshold life cycle stage. In another embodiment, the system 100 may request a new filter at operation 216 based upon user input to request a new filter. As shown in FIG. 5D, the user device 114d may include an interactive display 402 that allows a user to transmit data to the one or more servers 103. In the embodiment shown in FIG. 5D, the interactive display 402 includes buttons that enable a user to request replacement for a particular filter. A user request for replacement for a filter is transmitted to the one or more servers 103 and the system 100 may request a new filter. With continued reference to FIG. 3, if the system 100 does not request a new filter at operation 216, the method 200 ends.

If the system requests a new filter at operation 216, the method 200 proceeds to operation 218 and the system 100 transmits filter information for replacement. It is contemplated that the system 100 may transmit the information to a third party or transmit and store the information on one or more servers 103 or database 104. For example, the system 100 may transmit the filter information to a third party service provider, such as, for example a filtration company. The system 100 may send the filter specifications and may also transmit information on the filter's remaining life so the company can determine what filter is needed and the timeframe for installation. Alternatively or in addition, the system 100 may transmit the information to a server 103 or database 104. For example, the user may have a supply of filters and use the filter information stored on the server 103 or database 104 to determine which filter to replace and when to replace it. After the filter information is transmitted for replacement, the method 200 ends.

It is contemplated that the method 200 may be performed by the one or more servers 103. For example, the one or more servers 103 may receive filtration system data through the network 106 from the user devices 112, 114 and/or the database 104. The one or more servers 103 may process the fluid system and filtration system data and transfer the processed data to the user devices 112, 114. This allows users to receive alerts, notifications, and other data regarding the fluid system, the filtration system, and/or individual filters within the system.

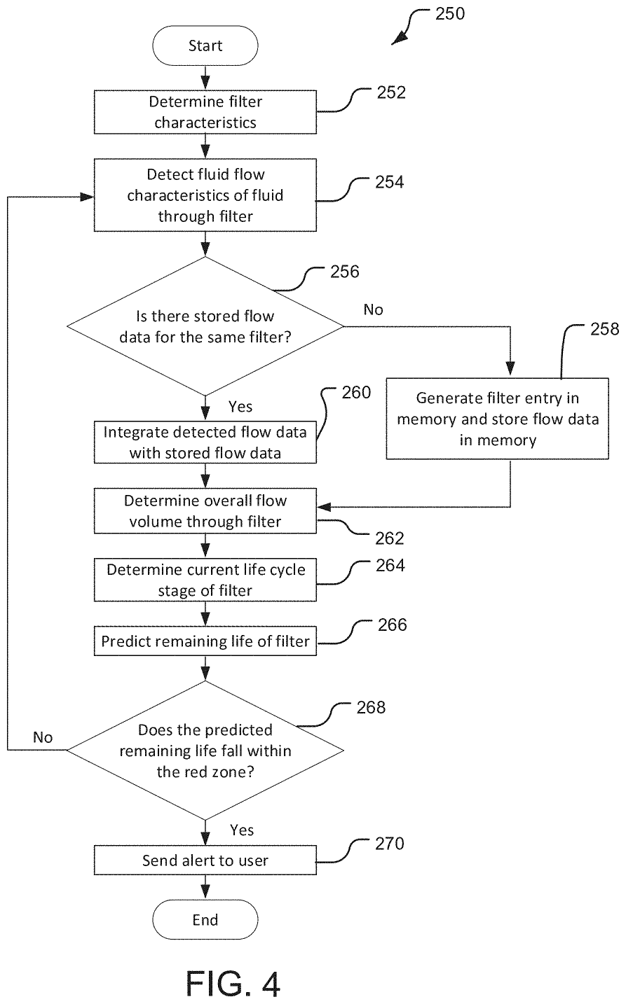

FIG. 4 is a flow chart illustrating one method 250 of predicting a remaining life of a filter using flow volume data to determine when to replace the filter. The method 250 may begin with operation 252 and the filter characteristics may be determined in a similar manner as in operation 202 of method 200. After operation 252, the method 250 may proceed to operation 254 and the fluid characteristics of fluid flowing through the filter may be determined in a similar manner as in operation 204 of method 200. After operation 254, the method 250 may proceed to operation 256 and the system 100 may determine whether there is stored flow data for the same filter. For example, flow data may be collected over time and stored in the system memory 506. As mentioned, the flow detection device 102 and/or sensors 110 may track each fluid flow event to each fluid device. Since the fluid devices may be associated with one or more filters, the system 100 may also track the amount of fluid flow through each filter and store the tracked volume in the system memory 506. In this manner, the actual volume of fluid that has passed through the filter since its installation may be known. The flow data may include other information as well, such as, for example, the fluid viscosity. Alternatively, there may be no stored flow data for the same filter. For example, the filter may be newly installed with no prior flow data detected.

If there is no stored flow data for the same filter, the method 250 may proceed to operation 258 and a filter entry may be generated in the system memory 506 and the flow data may be stored under the new filter entry. Any future data collected for the same filter may be stored under the filter entry in the system memory 506. By storing data specific to each filter in different filter entries in the system 100, the data may be more readily retrieved and each filter may be more accurately monitored individually. Accumulated filter-specific information may be stored and used as historical information, which may be another system input (along with the filter specifications and fluid characteristic information) used to determine the life cycle stage of a filter. The historical information may be stored on the system memory 506 or on a separate database 104.

If there is stored flow data for the same filter, the method 250 may proceed to operation 260 and the detected flow data may be integrated with the stored flow data for the same filter. The flow data may be maintained as separate files, such as, for example, a first detected flow, a second detected flow, a third detected flow, etc. Alternatively, the data may be combined, for example, the viscosity may be averaged for each detected flow event to produce an average viscosity of fluid passing through the filter, or the volume of flow per detected flow event may be accumulated or averaged.

After either operation 258 or operation 260, the method 250 may proceed to operation 262 and the overall fluid flow volume through the filter is determined. If operation 262 follows operation 258, then the overall flow volume through the filter may be obtained from the detected flow data. If operation 262 follows operation 260, then the overall flow volume through the filter may be obtained by adding the fluid flow volume from the detected flow data to the fluid flow volume from the stored flow data. By adding the detected flow volume to the stored flow volume each time there is a flow event, the system 100 may keep track of the total volume of fluid that passes through the filter. The cumulative flow volume may be associated with the filter and stored in the system memory 506.

After operation 262, the method 250 may proceed to operation 264 and the current life cycle stage of the filter may be determined. As mentioned, the life cycle stage may correlate to the volume of fluid that has passed through the filter. By tracking the total volume of fluid passing through each filter, the life cycle stage may be determined at any given point in time.

After operation 264, the method 250 may proceed to operation 266 and the remaining life of the filter may be determined. For example, based on the filter characteristics determined at operation 252, the maximum volume that can pass through the filter may be known. The filter's maximum volume capacity may correlate to the end of the filter's life. Additionally, the filter characteristics may provide information on when the filter was installed, such that the amount of time (t) that the filter has been functioning may be known. With the known actual fluid volume (AV) that has passed through the filter to time (t), and the known maximum volume (MV) capacity, the remaining life of the filter may be predicted. For example, the following equation may be used:

$$Remaining life = \frac{t ( MV - AV )}{AV}$$

The remaining life determination may also take into account historical data, as historical data may be used to predict future filter use. Historical data may include any previously collected fluid or filter data, usage trends or patterns, typical system behavior, or the like. For example, the flow detection device 102 may analyze the fluid characteristics collected at operation 254 and determine typical usage patterns and deviations from those patterns. Other data may be used by the flow detection device 102 and/or system 100 to predict usage patterns and flow characteristics. For example, environmental data (e.g., user input information, external flow source sensors, communication with smart devices (e.g., power switches, etc.), time of day, home/away status, weather, external flow data from nearby properties, event history, human behavior (e.g., toilet and sink typically used close in time, sink and dishwasher used together)) can be used to generate the pattern and correlate the flow events. By knowing typical usage patterns and behavior, future use of the filter can be predicted, and the system may predict how much fluid is likely to flow through the filter over time. By knowing how much fluid is likely to flow over time, the system can predict the remaining filter life.

After operation 266, the method 250 may proceed to operation 268 and the system 100 may determine whether the predicted remaining life falls within a red zone. The red zone or past other set threshold where towards the end of a filter's lifespan during which it is desirable to replace the filter. When the remaining life falls within the red zone, it may be desirable to replace the filter. The red zone may depend upon the filter specifications. For example, a rare filter found only in a foreign country may take more time to replace than a common filter available locally. The red zone may therefore be larger to accommodate the time it takes to obtain the filter. In this example, the red zone may correlate to the brand of filter; however, other factors may be taken into account when determining the appropriate red zone for each filter. Alternatively, the red zone may be based on user preferences. For example, a user may input or modify the red zone parameters for each filter.

If the predicted remaining life does not fall within the red zone, then the method 250 may return to operation 254 and the fluid flow characteristics of fluid flowing through the filter may again be determined. If the predicted remaining life falls within the red zone, then the method 250 may proceed to operation 270 and the system 100 may send an alert to a user to notify the user that the filter is within the red zone of its lifespan and may need to be replaced. In one example, the system 100 may also inform the user of the predicted timeframe remaining until the filter reaches its functional capacity and no longer functions properly. By knowing the actual timeframe remaining, a user may make an informed decision as to whether to request a new filter. For example, a user may know that it takes only a few days to get a new filter at the local store and hold off on purchasing one until it gets closer to the end of the filter's life.

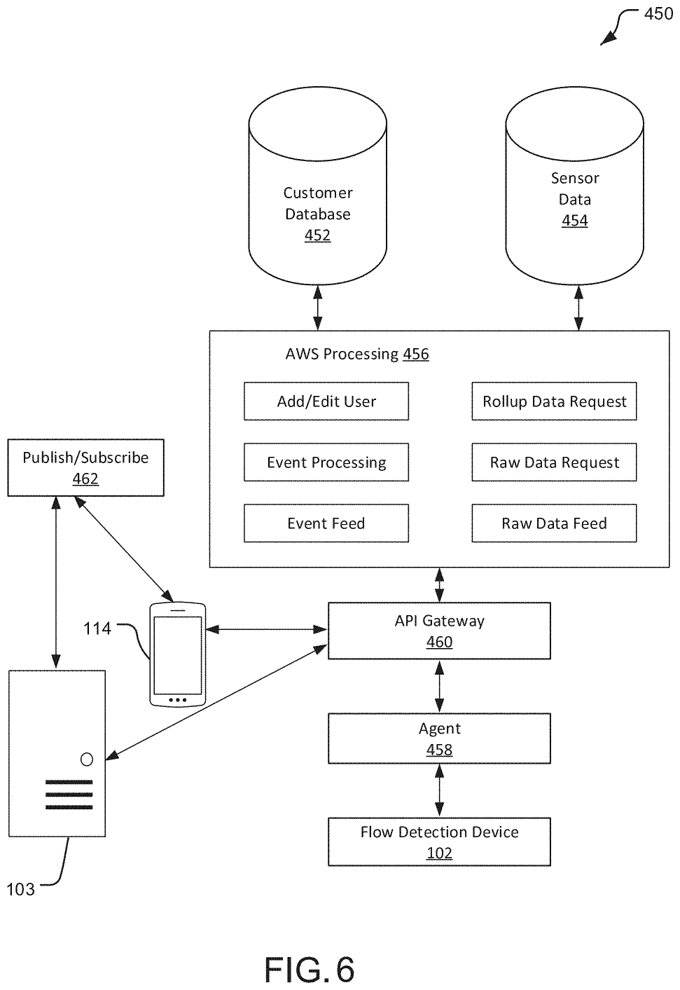

FIG. 6 illustrates a simplified diagram of one embodiment for a software architecture for the filtration system of FIG. 2. With reference to FIG. 6, the firmware elements for the architecture 450 may include the sensors 110, which may include a temperature sensor, pressure sensor, flow sensor, and the like; a user interface 402 (e.g., output LEDs), and/or the memory components 506. The firmware elements may be electronically connected to the processing elements 502, 518, 540 that are in electronic communication with the network 106 via the agent 458 which may be a microprocessor that connects one-to-one with the flow detection device 102. The agent 458 may act as a communication broker between the flow detection device 102 and an API gateway 460 (e.g., the AMAZON API Gateway). The agent 458 may also include memory components and store state information about the flow detection device 102, including timers that help to drive and trigger actions or events by the flow detection device 102.

The API gateway 360 may act as a single access point for all devices to send and receive information. Each API endpoint may call a unique lambda function to carry out requests. Examples of these calls include sending raw sensor data from the flow detection device 102 to a sensor database 454, requesting rolled up sensor data summaries, logging events, and/or sending messages to users.

The API gateway 460 interacts with the AWS processing 456. The AWS processing section 456 may include one or more independent lambda functions designed to carry out specialized tasks. These lambda functions can connect to the user database, sensor database, publish/subscribe module 462, and the API gateway 460. In many instances the functions may be fairly minimal data pass through and formatting, but in some instances the data analysis functions my process sensor data. The AWS processing module 456 may include add/edit users, event processing, event feed, roll up data request, raw data request, and/or raw data feed. The AWS processing module 456 may be operated from the network 106 (e.g., cloud computing) or may include functions run by the flow detection device 102 itself.

The publish/subscribe module 462 is a system used to send message to the applications and to a user (e.g., SMS text messages, emails, alerts, or the like). The messages may often be sent from a lambda function. Typically the publish/subscribe module 462 endpoints will be stored in a customer database 452 that includes the user contact information (e.g., phone number, email, etc.). The customer or user database 452 stores information about the associated application for the flow detection device 102 for a user and may connect a user to the flow detection device 102. The customer database 452 may be accessed by lambda functions.

The sensor database 454 is used to store all-time series data for the flow detection device 102. For example, the sensor database 454 may store data corresponding to flow rate, water temperature, water pressure, flow event markers, flow event type marker with probability, and the like. In some embodiments, the sensor data is tagged with a device identifier that corresponds to the agent 458 of the device. In some embodiments sensor database 454 may be accessed by lambda functions.

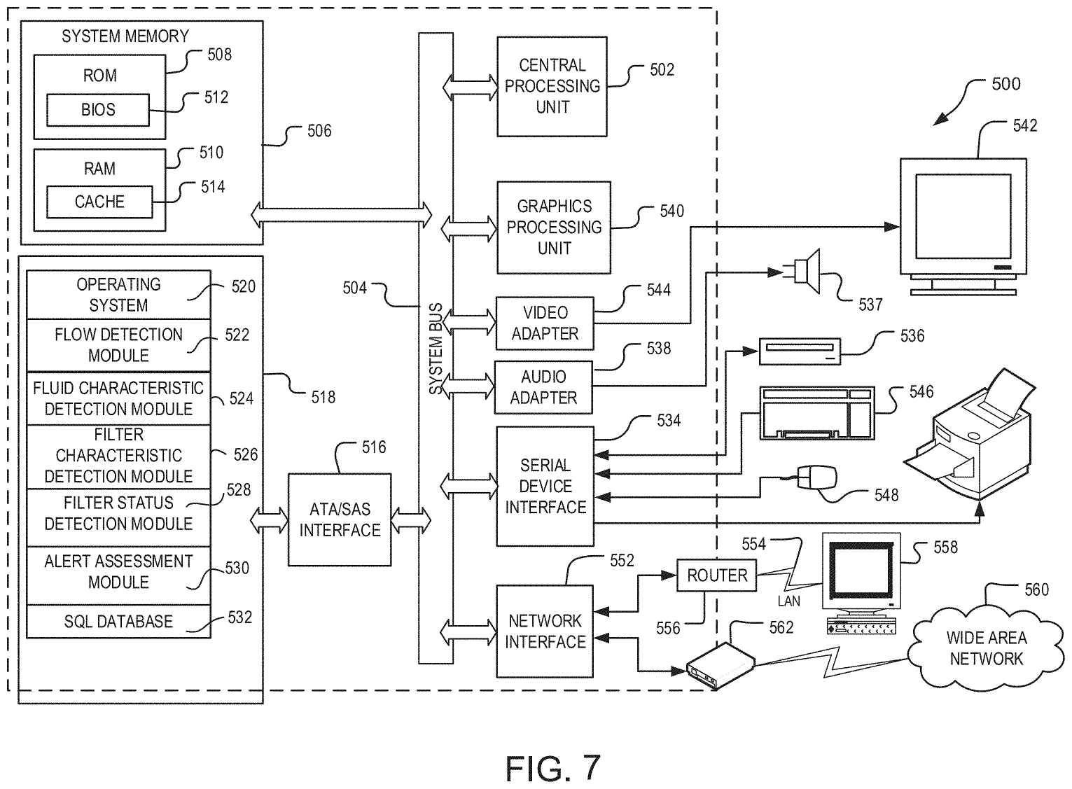

An exemplary computer-implemented filter monitoring system 500 for implementing the filter monitoring processes above is depicted in FIG. 7. The filter monitoring system 500 may be embodied in a specifically configured, high-performance computing system including a cluster of computing devices in order to provide a desired level of computing power and processing speed. Alternatively, the process described herein could be implemented on a computer server, a mainframe computer, a distributed computer, a personal computer (PC), a workstation connected to a central computer or server, a notebook or portable computer, a tablet PC, a smart phone device, an Internet appliance, or other computer devices, or combinations thereof, with internal processing and memory components as well as interface components for connection with external input, output, storage, network, and other types of peripheral devices. Internal components of the filter monitoring system 500 in FIG. 7 are shown within the dashed line and external components are shown outside of the dashed line. Components that may be internal or external are shown straddling the dashed line.

In any embodiment or component of the system described herein, the filter monitoring system 500 includes one or more processors 502 and a system memory 506 connected by a system bus 504 that also operatively couples various system components. There may be one or more processors 502, e.g., a single central processing unit (CPU), or a plurality of processing units, commonly referred to as a parallel processing environment (for example, a dual-core, quad-core, or other multi-core processing device). In addition to the CPU, the filter monitoring system 500 may also include one or more graphics processing units (GPU) 540. A GPU 540 is specifically designed for rendering video and graphics for output on a monitor. A GPU 540 may also be helpful for handling video processing functions even without outputting an image to a monitor. By using separate processors for system and graphics processing, computers are able to handle video and graphic-intensive applications more efficiently. As noted, the system may link a number of processors together from different machines in a distributed fashion in order to provide the necessary processing power or data storage capacity and access.

The system bus 504 may be any of several types of bus structures including a memory bus or memory controller, a peripheral bus, a switched fabric, point to point connection, and a local bus using any of a variety of bus architectures. The system memory 506 includes read only memory (ROM) 508 and random access memory (RAM) 510. A basic input/output system (BIOS) 512, containing the basic routines that help to transfer information between elements within the computer system 500, such as during start up, is stored in ROM 508. A cache 514 may be set aside in RAM 510 to provide a high speed memory store for frequently accessed data.

A data storage device 518 for nonvolatile storage of applications, files, and data may be connected with the system bus 504 via a device attachment interface 516, e.g., a Small Computer System Interface (SCSI), a Serial Attached SCSI (SAS) interface, or a Serial AT Attachment (SATA) interface, to provide read and write access to the data storage device 518 initiated by other components or applications within the filter monitoring system 500. The data storage device 518 may be in the form of a hard disk drive or a solid state memory drive or any other memory system. A number of program modules and other data may be stored on the data storage device 518, including an operating system 520, one or more application programs, and data files. In an exemplary implementation, the data storage device 518 may store a flow detection module 522, a fluid characteristic detection module 524, a filter characteristic detection module 526, a filter status detection module 528, an alert assessment module 530, as well as the fluid characteristics and filter data being processed and any other programs, functions, filters, and algorithms necessary to implement the filter monitoring procedures described herein. The data storage device 518 may also host a database 532 (e.g., a SQL database) for storage of filter characteristic information, fluid characteristic information, fluid flow data (e.g. flow signatures), user behavior data, historical fluid usage data, and other relational data necessary to perform the filter monitoring procedures described herein. Note that the data storage device 518 may be either an internal component or an external component of the computer system 500 as indicated by the hard disk drive 518 straddling the dashed line in FIG. 7.

In some configurations, the filter monitoring system 500 may include both an internal data storage device 518 and one or more external data storage devices 536, for example, a CD-ROM/DVD drive, a hard disk drive, a solid state memory drive, a magnetic disk drive, a tape storage system, and/or other storage system or devices. The external storage devices 536 may be connected with the system bus 504 via a serial device interface 534, for example, a universal serial bus (USB) interface, a SCSI interface, a SAS interface, a SATA interface, or other wired or wireless connection (e.g., Ethernet, Bluetooth, 802.11, etc.) to provide read and write access to the external storage devices 536 initiated by other components or applications within the filter monitoring system 500. The external storage device 536 may accept associated computer readable media to provide input, output, and nonvolatile storage of computer readable instructions, data structures, program modules, and other data for the filter monitoring system 500.

A display device 542, e.g., a monitor, a television, or a projector, or other type of presentation device may also be connected to the system bus 504 via an interface, such as a video adapter 540 or video card. Similarly, audio devices, for example, external speakers, headphones, or a microphone (not shown), may be connected to the system bus 504 through an audio card or other audio interface 538 for presenting audio, for example, to a visually impaired user.

In addition to the display device 542 and audio device 547, the filter monitoring system 500 may include other peripheral input and output devices, which are often connected to the processor 502 and memory 506 through the serial device interface 544 that is coupled to the system bus 504. Input and output devices may also or alternately be connected with the system bus 504 by other interfaces, for example, a universal serial bus (USB), an IEEE 1494 interface (“Firewire”), a parallel port, or a game port. A user may enter commands and information into the filter monitoring system 500 through various input devices including, for example, a keyboard 546 and pointing device 548, for example, a computer mouse. Other input devices (not shown) may include, for example, a joystick, a game pad, a tablet, a touch screen device, a satellite dish, a scanner, a facsimile machine, a microphone, a digital camera, and a digital video camera.

Output devices may include a printer 550. Other output devices (not shown) may include, for example, a plotter, a photocopier, a photo printer, a facsimile machine, and a printing press. In some implementations, several of these input and output devices may be combined into single devices, for example, a printer/scanner/fax/photocopier. It should also be appreciated that other types of computer readable media and associated drives for storing data, for example, magnetic cassettes or flash memory drives, may be accessed by the computer system 500 via the serial port interface 544 (e.g., USB) or similar port interface. In some implementations, an audio device such as a loudspeaker may be connected via the serial device interface 534 rather than through a separate audio interface.

The filter monitoring system 500 may operate in a networked environment using logical connections through a network interface 552 coupled with the system bus 504 to communicate with one or more remote devices. The logical connections depicted in FIG. 7 include a local area network (LAN) 554 and a wide area network (WAN) 560. Such networking environments are commonplace in home networks, office networks, enterprise wide computer networks, and intranets. These logical connections may be achieved by a communication device coupled to or integral with the filter monitoring system 500. As depicted in FIG. 7, the LAN 554 may use a router 556 or hub, either wired or wireless, internal or external, to connect with remote devices, e.g., a remote computer 558, similarly connected on the LAN 554. The remote computer 558 may be another personal computer, a server, a client, a peer device, or other common network node, and typically includes many or all of the elements described above relative to the computer system 500.

To connect with a WAN 560, the filter monitoring system 500 typically includes a modem 562 for establishing communications over the WAN 560. Typically the WAN 560 may be the Internet. However, in some instances the WAN 560 may be a large private network spread among multiple locations, or a virtual private network (VPN). The modem 562 may be a telephone modem, a high speed modem (e.g., a digital subscriber line (DSL) modem), a cable modem, or similar type of communications device. The modem 562, which may be internal or external, is connected to the system bus 504 via the network interface 552. In alternate embodiments the modem 562 may be connected via the serial port interface 544. It should be appreciated that the network connections shown are exemplary and other means of and communications devices for establishing a network communications link between the computer system and other devices or networks may be used.

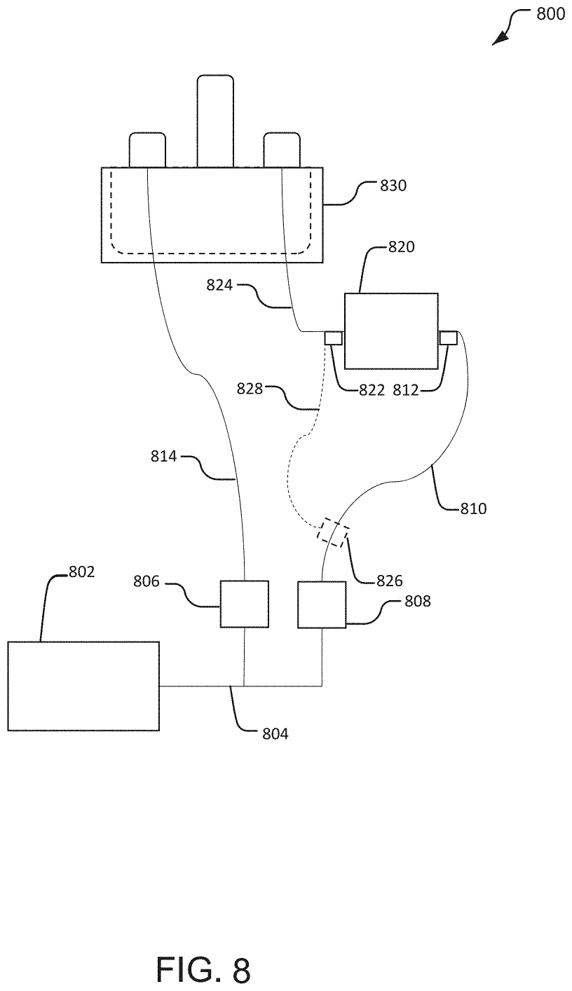

Turning ahead in the drawings to FIG. 8, a filter monitoring system can be used to track performance of one or more filters in the filter monitoring system. Generally, as a flow rate of fluid (such as water) through a filter decreases the performance of the filter typically decreases correspondingly. For example, if a filter has accumulated dirt, minerals, compounds, materials, and/or other materials foreign to the filter, the flow rate of water through the filter will be less than when the filter was devoid of dirt, minerals, compounds, materials and/or other materials foreign to the filter. Accordingly, tracking the flow rate through or directly after a filter can be used to determine a quality or efficiency of the filter.

FIG. 8 depicts a block diagram of a non-limiting embodiment of a filter monitoring system 800. The filter monitoring system 800 can be used in commercial or residential settings. The filter monitoring system 800 can include a water source, such as a house flow meter 802, which may be the flow detection device 102. The filter monitoring system also can include a fluid path from the house fluid meter 802 to a first or hot water source valve 806 and a second or cold water source valve 808. Although not shown in FIG. 8, a water heater may be included with or fluidly coupled to the hot water source valve 806. The filter monitoring system 800 can terminate at one or more fluid devices. While, in FIG. 8, the filter monitoring system 800 terminates at a sink faucet 830, other filter monitoring systems contemplated herein can terminate at any fluid devices described above, such as a shower faucet, a dishwasher, a washing machine, an outdoor faucet, and so on.

In many embodiments, the filter monitoring system 800 includes a first flow path 824 fluidly coupled to the fluid device 830 and a filter 820 fluidly coupled to the first flow path 824 distal fluid device 830. The fluid flow path 824 can include a pipe, hose, or the like. The filter 820 can include any filter described elsewhere in this disclosure, but in some examples is a charcoal block filter. The filter monitoring system 800 also includes a downstream filter or downstream flow sensor 822 fluidly connected to the first flow path 824. The downstream filter sensor 822 can include any sensor configured to detect a downstream flow rate of fluid flowing or exiting from at least the filter 820 through the first flow path 824. For example, the downstream flow sensor 822 can determine or otherwise track a flow rate of fluid exiting the filter 820 in gallons per minute. In many embodiments, the downstream flow sensor 822 is fluidly connected to the first flow path 824 directly after and/or adjacent to the filter 820. Positioning of the downstream flow sensor 822 on the first flow path 824 directly after and/or adjacent to the filter 820 allows the downstream flow sensor 822 to determine the downstream or exit flow rate of the fluid passing through the filter 820 just as the fluid leaves the filter 820.

Fluid may enter the filter 820 through one of a number of different fluid paths according to different embodiments of the filter monitoring system. For example, in some embodiments, a fluid path may allow direct fluid communication between the filter 820 and the house flow meter 802 (or flow detection device 102), the hot water source valve 806, or the cold water source valve 808. In other embodiments, such as the non-limiting embodiment shown in FIG. 8, the filter monitoring system 800 includes a second flow path 810 fluidly coupled to the filter 820, the second flow path 810 being fluidly coupled to a source valve such as the cold water source valve 808. While the embodiment shown in FIG. 8 includes the downstream flow sensor 822, the filter 820, and an upstream or entrance flow sensor 812 on fluid paths in fluid communication with the cold water switch valve 808, it is contemplated that in other embodiments, the downstream flow sensor 822, a filter 820, and the upstream flow sensor 812 may, alternatively or additionally, be on fluid paths in fluid communication with the hot water switch valve 806.

In many embodiments, the filter monitoring system 800 includes the upstream flow sensor 812 fluidly connected to the second flow path 810. The upstream or entrance flow sensor 812 can include any sensor that detect an initial flow rate of fluid flowing through the second flow path 810 into the filter 820, e.g., fluid flow sensor. For example, the upstream flow sensor 812 can determine or otherwise track a flow rate of fluid entering the filter 820 in gallons per minute. In many embodiments, the upstream flow sensor 812 is fluidly connected to the second flow path 810 directly before and/or adjacent to the filter 820. Positioning of the upstream flow sensor 812 on the second flow path 810 directly before and/or adjacent to the filter 820 allows the upstream flow sensor 812 to determine the initial flow rate of the fluid passing through the second fluid path 810 just as the fluid enters the filter 820.

In many embodiments, the filter monitoring system 800 includes a processing element. The processing element can include any processing elements described elsewhere in this disclosure, such as but not limited to the processor 502. The processing element is configured to determine a life cycle stage of the filter 820 based on at least the downstream flow rate detected by the downstream flow sensor 822. For example, the processing system can compare the downstream flow rate detected by the downstream flow sensor 822 to typical or desired flow rates for the filter 820, and determine that the life cycle stage of the filter 820 requires replacement or does not require replacement. As a specific example, the downstream sensor detects the flow rate (e.g., gpm) exiting the filter and transmits the data to the flow detection device 102, the server 103, or to an on-board processing element, which then compares the exit flow rate to a known flow rate entering the filter and/or typical flow rates exiting the filter falling with a predetermined range of effectiveness. That is, the system may be in communication with a database or other memory structure that includes a range of flow rates that correspond with filter effectiveness and the system my compare the flow rate of the filter against the database to determine that the exit flow rate falls within the effective range, as compared to a range falling outside of the effective flow rate.

In other embodiments, the processing element of the filter monitoring system 800 determines the life cycle stage of the filter 820 based on at least a difference between the initial flow or entering flow rate detected by the upstream flow sensor 812 and the final, exiting, or downstream flow rate detected by the final fluid sensor 822. For example, the processing element can determine if a decrease in the flow rate between the initial flow rate and the final flow rate indicates that filter 820 is nearing or at the end of its life cycle and requires replacement, e.g., a drop off between the entering and exit flow rates exceeds a predetermined value, ratio, or percentage relationship between the two flow rates. The processing element also can determine that a decrease in the flow rate between the initial flow rate and the final flow rate indicates that the filter 820 does not need replacement.

In some embodiments, the filter monitoring system 800 also can include a switch valve 826 fluidly coupled to the second flow path 810 between the cold water source valve 808 and the filter 820. In this and other embodiments, the filter monitoring system 800 also can include a bypass flow path 828 fluidly coupled to the switch valve 826 and fluidly connected to the downstream flow sensor 822. The switch valve 826 is operable between a first position and a second position. When the switch valve 826 is in the first position, the switch valve 826 allows fluid communication between the cold water source valve 808 and the filter 820, and prevents fluid communication between the cold water source valve 808 and the downstream flow sensor 822. When the switch valve 826 is in the second position, the switch valve 826 allows fluid communication between the cold water source valve 808 and the downstream flow sensor 822, and prevents fluid communication between the cold water source valve 808 and the filter 820.

In embodiments of the filter monitoring system 800 including the switch valve 826 and the bypass flow path 828, the processing element can be further configured to determine a quality of fluid flow in the filter monitoring system 800 without (or bypassing) the filter 820. For example, the processing element can determine a fluid quality of fluid in the filter monitoring system 800 without the filter 820 being included in the filter monitoring system 800 based on the fluid flow rate detected by the downstream flow sensor 822 when the switch valve 826 is in the second position that allows fluid communication between the cold water source valve 808 and the filter 820 while preventing fluid communication between the cold water source valve 808 and the downstream flow sensor 822.

In many embodiments, the processing element of the filter monitoring system 800 also determines and tracks a flow rate efficiency of the filter 820 over time. The flow rate efficiency can include a correlation of the effectiveness of the filter 820 to flow rate over time. For example, the processing element can determine an average flow rate or a random flow rate of fluid through the filter 820 at each of a predetermined period of time, such as each day, each week, and/or each month. The average flow rate or the random flow rate through the filter 820 can be based entirely on the final flow rate detected by the downstream flow sensor 822, or alternatively be based on the difference between the initial flow rate and the final flow rate as detected by the upstream flow sensor 812 and the downstream flow sensor 822, respectively. The flow rate efficiency also can be determined by comparing the average flow rate or the random flow rate at each period of time to a flow rate for peak efficiency for the filter 820.

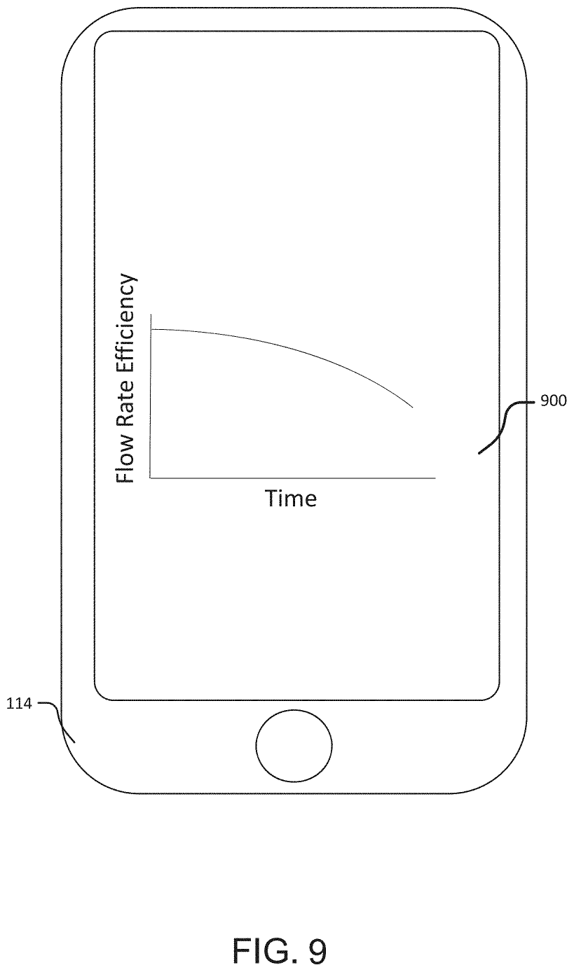

Turning to FIG. 9, in many embodiments, the processing element is further configured to coordinate display of a graph or other relationship depiction on a user interface 900 of the user device 114. The graph on the user interface 900 depicts the flow rate efficiency of the filter 820 over a period of time. As shown in the example of FIG. 9, the flow rate efficiency of filters generally decreases over time. When the flow rate efficiency of a filter drops below a certain threshold, it may be desirable and/or critical for the filter to be replaced. Accordingly, the processing element can be further configured to transmit an alert to the user device 114 when the flow rate efficiency of the filter is below a predetermine flow rate efficiency threshold. Alternatively or additionally, the system may also automatically place an order (e.g., through an e-commerce platform or an internal system) for a new filter for the user's location.

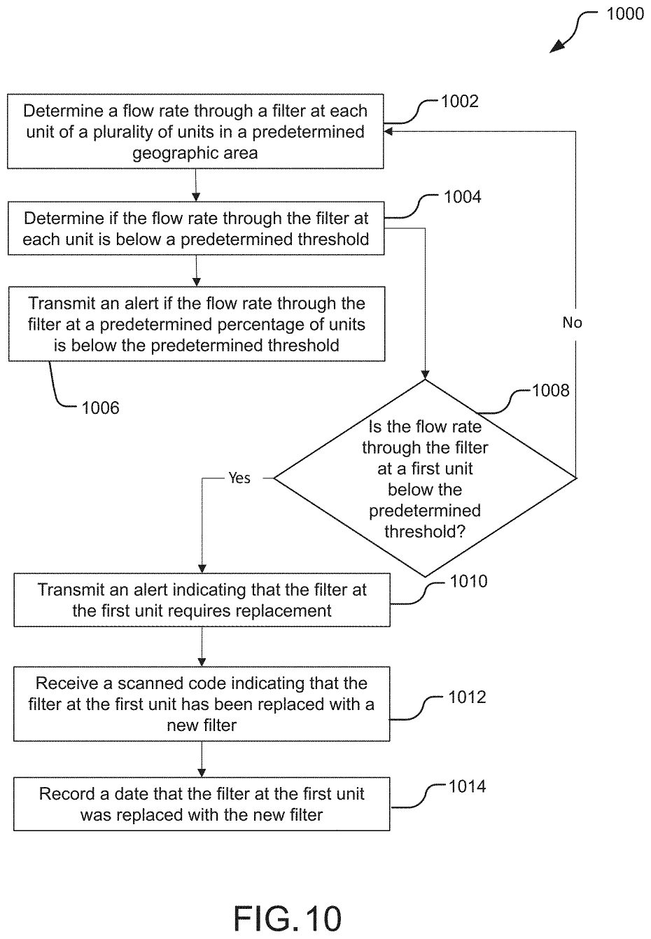

Turning to FIG. 10, which includes a flow chart illustrating a method 1000 of tracking compliance to one or more water requirements by a water utility. Certain geographic areas may require different filtration systems than other geographic areas. For example, a certain geographic area may be found to have levels of lead or other contaminants in the water that exceed a governmental standard or other threshold. In these instances, filters are highly advantageous to remove lead from the water. Moreover, a specific type of filter designed to remove lead from the water may be used in this geographic area to ensure the water at each unit (such as a house, apartment, office, or other building) does not include lead at levels exceeding a predetermined threshold. In these areas, however, even if a filter is placed at each unit in the geographic area, a water utility company previously could not track use and/or life cycle stage of the filter at each unit. Thus, while a unit may include a filter designed to remove harmful levels of lead from the water, the life cycle stage of the filter may result in harmful levels of lead passing through the filter.

To solve this problem, embodiments of method 1000 allow a water utility company to determine if the filter of one or more units in a geographic area need replacement. Embodiments of method 1000 also allow a water utility to be alerted when the flow rate drops below a predetermined threshold at a predetermined percentage of units in a geographic area. This allows a water utility company determine whether home owners are safe from water contamination in areas of potential water contamination.

The method 1000 may begin with operation 1002 of determining a flow rate through a filter at each unit of a plurality of units in a predetermined geographic area. The flow rate can be determined by one or more processing elements in communication with a plurality of flow sensors each fluidly connected to one of a plurality of filters at each unit of a plurality of units in the predetermined geographic area. The filter at each unit can include any of the filters described herein, and the flow sensors can include any of the sensor described herein. Moreover, the filter at each unit may be a part of a filter monitoring system, such as the filter monitoring system 800 described above.

After determining the flow rate through a filter at each unit of a plurality of units in a predetermined geographic area at operation 1002, the method 1000 may proceed to operation 1004 of determining if the flow rate through the filter at each unit is below a predetermined threshold. In many embodiments, the one or more processing elements can determine if the flow rate through filter at each unit is below a predetermined threshold. The predetermined threshold can, for example, be for a predetermined gallons per minute flow rate. The predetermined threshold can be specific to the filter and/or the predetermined geographic area.

After determining if the flow rate through the filter at each unit is below a predetermined threshold at operation 1004, the method 1000 may proceed to operation 1006 of transmitting an alert if the flow rate through the filter at a predetermined percentage of units is below the predetermined threshold. The one or more processing units can transmit the alert if the flow rate through the filter at a predetermined percentage of units is below the predetermined threshold. For example, if the flow rate through the filter at a predetermined percentage of units, such as 90% of units, is below a predetermined flowrate threshold, this determination may indicate the geographical area has a potential water contamination. An alert transmitted to the water utility company and/or customers of the water utility company allow cautionary measures to be taken to prevent illness or death.

After determining if the flow rate through the filter at each unit is below a predetermined threshold at operation 1004, the method 1000 also may proceed to operation 1008 of determining if the flow rate through the filter at a first unit of the plurality of units is below the predetermined threshold. If the flow rate through the filter at the first unit is not below the predetermined threshold, the method 1000 may return to operation 1002. If the flow rate through the filter at the first unit is below the predetermined threshold, the method may proceed to operation 1010 of transmitting an alert indicating that the filter at the first unit requires replacement. The alert may be transmitted to either the water utility company or the customer at the unit, or both.

Once an alert has been received by the water utility company or the customer at the unit, a new filter may be shipped to the customer at the unit, delivered to the customer at the unit, or otherwise received by the customer at the unit. For example, the water utility company may send a service technician with the new filter to the unit to replace the filter at the unit. Whether the new filter is shipped or delivered, the new filter can be scanned at the time of instillation at the unit. For example, the new filter can include a code for scanning on either a box or the filter itself. Once scanned, the code can be transmitted to the processing element. Thus, after transmitting the alert indicating that the filter at the first unit requires replacement at operation 1010, the method 1000 may proceed to operation 1012 of receiving a scanned code indicating that the filter at the first unit has been replaced with a new filter.

After receiving the scanned code indicating that the filter at the first unit has been replaced with a new filter at operation 1012, the method 1000 may proceed to operation 1014 of recording a date that the filter at the first unit was replaced with the new filter. This allows the water utility company to have a database of when filters where installed at units and when filters may need to be replaced at units.

The technology described herein may be implemented as logical operations and/or modules in one or more systems. The logical operations may be implemented as a sequence of processor-implemented steps executing in one or more computer systems and as interconnected machine or circuit modules within one or more computer systems. Likewise, the descriptions of various component modules may be provided in terms of operations executed or effected by the modules. The resulting implementation is a matter of choice, dependent on the performance requirements of the underlying system implementing the described technology. Accordingly, the logical operations making up the embodiments of the technology described herein are referred to variously as operations, steps, objects, or modules. Furthermore, it should be understood that logical operations may be performed in any order, unless explicitly claimed otherwise or a specific order is inherently necessitated by the claim language.

In some implementations, articles of manufacture are provided as computer program products that cause the instantiation of operations on a computer system to implement the procedural operations. One implementation of a computer program product provides a non-transitory computer program storage medium readable by a computer system and encoding a computer program. It should further be understood that the described technology may be employed in special purpose devices independent of a personal computer.

The above specification, examples and data provide a complete description of the structure and use of exemplary embodiments of the invention as defined in the claims. Although various embodiments of the claimed invention have been described above with a certain degree of particularity, or with reference to one or more individual embodiments, those skilled in the art could make numerous alterations to the disclosed embodiments without departing from the spirit or scope of the claimed invention. Other embodiments are therefore contemplated. It is intended that all matter contained in the above description and shown in the accompanying drawings shall be interpreted as illustrative only of particular embodiments and not limiting. Changes in detail or structure may be made without departing from the basic elements of the invention as defined in the following claims.

What is claimed is:

1. A method of tracking a filter lifespan in a fluid supply system, comprising:
determining specifications of a filter;
determining, by a flow detection device, fluid characteristics of fluid flowing through the filter, wherein the fluid characteristics comprise fluid flow data;
analyzing the fluid flow data to determine fluid flow through the filter; and
determining a lifespan stage of the filter based on the fluid flow through the filter.

2. The method of claim 1, wherein the fluid characteristics further comprise at least one of fluid quality and composition data, fluid temperature data, and fluid pressure data, wherein the fluid characteristics are further determined by a sensor and used to determine the lifespan stage of the filter.

3. The method of claim 2, wherein the fluid quality and composition data comprises at least one of pH, salinity, electric conductivity, dissolved oxygen, chemicals, and nutrients.

4. The method of claim 1, wherein the fluid flow detection device further comprises a sensor capable of detecting an actual flow volume through the filter.

5. The method of claim 4, wherein the sensor is positioned within the fluid supply system.

6. The method of claim 5, wherein the sensor is positioned within a water device associated with the filter.

7. The method of claim 1, wherein the specifications of the filter comprise at least one of an age, brand, model, make, type, and maximum volume capacity of the filter, wherein the maximum volume capacity corresponds to an end of the lifespan of the filter.

8. The method of claim 7, wherein determining the lifespan stage of the filter is further based on the maximum volume capacity of the filter.

9. The method of claim 1, further comprising sending at least one of an alert and a request for a new filter when the lifespan stage of the filter exceeds a threshold lifespan stage.

10. The method of claim 9, wherein the threshold lifespan stage corresponds to a percentage of volume capacity of the filter.

11. The method of claim 10, wherein the threshold lifespan stage corresponds to a percentage between 80 and 95 percent volume capacity.

12. A filter monitoring system, comprising:
a first flow path;
at least one fluid device fluidly coupled to the first flow path;
a filter fluidly coupled to the first flow path distal to the at least one fluid device;
a downstream flow sensor fluidly connected to the first flow path between the at least one fluid device and the filter, the downstream flow sensor configured to detect a downstream flow rate of fluid exiting at least the filter through the first flow path;
a processing element in communication with the downstream flow sensor and a user device, wherein the processing element determines a life cycle stage of the filter based on at least the downstream flow rate detected by the downstream flow sensor.

13. The filter monitoring system of claim 12, further comprising:
a second flow path fluidly coupled to the filter; and
an upstream flow sensor fluidly connected to the second flow path and configured to detect an entering flow rate of fluid flowing through the second flow path into the filter;
wherein the processing element determines the life cycle stage of the filter based on at least a difference between the entering flow rate detected by the upstream flow sensor and the exit flow rate of the fluid detected by the downstream fluid sensor.

14. The filter monitoring system of claim 13, further comprising:
a source valve fluidly coupled to the second flow path distal to the filter;
a switch valve fluidly coupled to the second flow path between the source valve and the filter; and
a bypass flow path fluidly coupled to the switch valve and fluidly connected to the downstream flow sensor;
wherein:
the switch valve is operable between:
a first position allowing fluid communication between the source valve and the filter and preventing fluid communication between the source valve and the downstream flow sensor; and
a second position allowing fluid communication between the source valve and the downstream flow sensor, and preventing fluid communication between the source valve and the filter;
the downstream flow sensor is further configured to detect a fluid flow rate of fluid flowing from the source valve through the bypass flow path; and
the processing element is further configured to determine a fluid quality without the filter based on the fluid flow rate detected by the downstream flow sensor when the switch valve is in the second position.

15. The filter monitoring system of claim 14, wherein the source valve is a cold water source valve.

16. The filter monitoring system of claim 13, wherein the processing element is further configured to:
determine and track a flow rate efficiency of the filter over time; and
coordinate display of a graph on an interface of the user device, the graph depicting the flow rate efficiency of the filter over the time.

17. The filter monitoring system of claim 16, wherein the processing element is further configured to transmit an alert to the user device when the flow rate efficiency of the filter is below a predetermined flow rate efficiency threshold.

18. A method of tracking compliance to one or more water requirements by a water utility, the method comprising:
with one or more processing elements in communication with a plurality of flow sensors each fluidly connected to one of a plurality of filters at each unit of a plurality of units in a predetermined geographic area, determining a flow rate through the filter at each unit of the plurality of units;
with the one or more processing elements and for the filter at each unit of the plurality of units, determining if the flow rate through the filter at the unit is below a predetermined threshold; and
with the one or more processing units, transmitting an alert to the water utility if the flow rate through the filter at a predetermined percentage of units of the plurality of units in the predetermined geographic area is below the predetermined threshold.

19. The method of claim 18, further comprising:
with the one or more processing elements, determining the flow rate through the filter at a first unit of the plurality of units is below the predetermined threshold;
with the one or more processing elements, transmitting an alert to the water utility indicating that the filter at the first unit requires replacement;
with the one or more processing elements, receiving a scanned code indicating that the filter at the first unit has been replaced with a new filter; and
with the one or more processing elements, recording a date that the filter at the first unit was replaced with the new filter.

20. The method of claim 18, wherein determining the flow rate through the filter for each unit of the plurality units comprises comparing an upstream flow rate detected by an upstream sensor to a downstream flow rate detected by a downstream filter measuring flow rate of fluid through the filter.
